(19) United States
(12) Patent Application Publication
(10) Pub. No.: US 2026/0212628 A1
(43) Pub. Date: Jul. 23, 2026

(54) COMPUTER VISION METHODS, SYSTEMS, AND DEVICES FOR INFERRING COUNTS OF OCCLUDED OBJECTS

(71) Applicant: DELICIOUS AI LLC, Lehi, UT (US)

(72) Inventors: Porter Reece JENKINS, Lehi, UT (US); Kyle William ARMSTRONG, Lehi, UT (US); Wade WILKEY, Lehi, UT (US); Brad CURTIS, Lehi, UT (US)

(21) Appl. No.: 19/137,184

(22) PCT Filed: Dec. 15, 2023
(86) PCT No.: PCT/US2023/084221

§ 371 Date: Jun. 9, 2025

Related U.S. Application Data
(60) Provisional application No. 63/387,744, filed on Dec. 16, 2022.

(51) Int. Cl. G06V 10/25; G06N 3/045; G06N 3/0464; G06N 3/08; G06V 10/766; G06V 10/82; G06V 20/64

(52) U.S. Cl. CPC G06V 10/25; G06N 3/045; G06N 3/0464; G06N 3/08; G06V 10/766; G06V 10/82; G06V 20/64; G06V 2201/07

(57) ABSTRACT

Methods and systems are provided system for inferring counts of objects. The system obtains one or more point beam proposals associated with one or more detected objects in a scene. Each of the one or more point beam proposals corresponds to a 3D geometry extended from a 2D shape associated with a respective object of the one or more detected objects. Each of the one or more point beam proposals is associated with a respective set of points of a point cloud. The system further determines a regression-based count estimation for the one or more detected objects in the scene utilizing the one or more point beam proposals.

### FIELD OF THE DISCLOSURE

The present disclosure relates to systems and methods for automatic identifying and counting of objects in three-dimensional space, and particularly in retail, storage, or warehouse environments.

### BACKGROUND

Retailers of all sizes, including convenience stores, grocery stores, one-stop-shopping centers, specialized retailers such as electronics, apparel, or outdoor good stores, may sell tens to hundreds of thousands or more unique products in thousands of product classes. Products must be suitably arranged on up to hundreds of different shelving units, refrigeration units, and kiosks in different locations of the store, determining a desired selection, quantity, and arrangement of products in the above-mentioned locations is a highly involved and as yet unsolved problem.

This is compounded by the dynamic needs and preferences of consumers throughout the course of the year and even the course of the day and based on a location of a store, as different products become more or less popular based on the time of year, the weather, demographics, and/or the time of day, in response to marketing campaigns, as prices and availability of products change, and as certain products become less popular over time and newer products become more popular as they are adopted by consumers. As a result, the retailing shopping experience is an extremely visually complex experience for consumers, with complex emotional responses by the consumers.

The need to properly identify and arrange objects in a space applies equally to warehouses such as fulfillment and distribution centers, as the identity and quantity of objects must be properly determined and monitored to maintain operational efficiency and supply-chain requirements, and with millions of items being held in and distributed through the fulfillment center on any given day. This, too, is constantly changing in view of changing preferences by consumers and changing product offerings. With the movement of goods being increasingly performed by automated systems rather than by humans, the need for a system and method for automatically and accurately identifying and counting 3D objects is increasingly important.

Vendors, retailers and inventory managers currently rely on expensive audits, frequently done manually, in which products are counted or tracked, shelf space is assessed, and the number of products is calculated and ordered. An end result of this process is to provide detailed recommendations to sales people and retailers regarding what, where, and how much of an object or product to provide. This process is still a necessarily manual and specialized process requiring significant time and expense, and must be repeated at regular intervals in view of the dynamic factors mentioned above, namely the changing preferences of consumers throughout the year and as products themselves become more or less popular with consumers. The high cost of such audits often renders such services out of reach for smaller storekeepers and retailers. Further, the manual nature of such processes inevitably results in inaccuracies.

Taking stock of inventory for the purposes of inventory review, financial audits, due diligence, and other purposes is also a manual process requiring the efforts of temporary workers to identify and count objects in a space. Such work is time consuming, expensive, physically demanding, tedious, and subject to human error in identifying and counting inventory in a store or warehouse.

Other existing approaches to the problem of arranging products and inventory rely on image recognition technology to identify two-dimensional features such as stock-keeping units (SKUs), but this approach is limited in its effectiveness by the fact that products are necessarily three-dimensional (3D), are densely stacked, and are normally stocked several items deep on a shelf, with inevitable mismatches, known as “disruptors,” due to consumers or stockers replacing objects on shelves in the wrong location. Further, objects that have been bumped out of the proper position by consumers may also be mistaken or not recognized during image recognition. Existing image recognition approaches also may incorrectly estimate the 3D bounds of objects. These difficulties render any assessment by existing image recognition approaches, particularly of a number of objects on a shelf at any given time, highly suspect.

Approaches that utilize 3D object detectors, such as those used in autonomous driving, typically train neural networks while performing regression in 3D space to make predictions about the location of objects in a scene, rather than a count of the objects, and require collecting samples of 3D scenes and bounding boxes, but such processes are tedious and not directly necessary for count inference. Applying such object detectors disadvantageously requires collecting thousands of samples of 3D scenes with human-labeled 3D bounding boxes, which is time consuming, expensive, and difficult to scale as more classes of objects are added to the model,

Such object detectors also are poorly adapted to detecting densely spaced objects which are likely to overlap in the field of view of the camera and make it difficult to capture shape information of the objects. Additionally, such object detectors are poorly adapted to classifying different objects with the same geometric shape due to the absence of semantic visual information, such as RGB images. For example, such object detectors are poorly adapted to distinguishing between similarly shaped 2-liter bottles of different flavors of soft drinks or different varieties of loaves of bread, as the different varieties of soft drinks and bread have the same or a very similar point cloud shape. In view of these limitations, 3D object detectors are insufficient to performing consistent and accurate product classification.

Arranging, stocking, and maintaining inventory on aisles of a store remains a highly involved process requiring immense marketing insight and management of individual product placement, as there is as yet no reliable and quantifiable method for inferring counts of 3D objects and automatically, rather than manually, assessing the ideal placement of products. Often the success or failure of a display or arrangement to generate increased sales or foot traffic cannot be attributed to a particular factor, making successes difficult to replicate.

3D scene understanding is an important problem that has experienced great progress in recent years, in large part due to the development of state-of-the-art methods for 3D object detection. However, the performance of 3D object detectors can suffer in scenarios where extreme occlusion of objects is present and/or where the number of object classes is large.

### SUMMARY

At least some principles of the present disclosure relate to the problem of inferring 3D counts from densely packed scenes with one or more sets of heterogeneous objects. At least some disclosed embodiments involve a regression-based method that uses (i) a 2D object detector for fine-grained classification and localization and (ii) an embedding module configured to generate geometric embeddings (e.g., a PointNet backbone). At least some disclosed embodiments implement a network that processes fused data from images and point clouds for end-to-end learning of counts.

A system is provided for inferring counts of objects. The system comprises: one or more processors; and one or more hardware storage devices that store instructions that are executable by the one or more processors to configure the system to: obtain one or more point beam proposals associated with one or more detected objects in a scene, wherein each of the one or more point beam proposals corresponds to a 3D geometry extended from a 2D shape associated with a respective object of the one or more detected objects, and wherein each of the one or more point beam proposals is associated with a respective set of points of a point cloud; and determine a regression-based count estimation for the one or more detected objects in the scene utilizing the one or more point beam proposals.

A method is provided for inferring counts of objects, the method comprising: obtaining one or more point beam proposals associated with one or more detected objects in a scene, wherein each of the one or more point beam proposals corresponds to a 3D geometry extended from a 2D shape associated with a respective object of the one or more detected objects, and wherein each of the one or more point beam proposals is associated with a respective set of points of a point cloud; and determining a regression-based count estimation for the one or more detected objects in the scene utilizing the one or more point beam proposals.

One or more hardware storage devices are provided that store instructions that are executable by one or more processors of a system to configure the system to: obtain one or more point beam proposals associated with one or more detected objects in a scene, wherein each of the one or more point beam proposals corresponds to a 3D geometry extended from a 2D shape associated with a respective object of the one or more detected objects, and wherein each of the one or more point beam proposals is associated with a respective set of points of a point cloud; and determine a regression-based count estimation for the one or more detected objects in the scene utilizing the one or more point beam proposals.

A method is provided for training a set of neural networks to infer counts of objects, comprising: providing a set of training data as input to a set of neural networks, the set of training data comprising 3D point cloud data and 2D image data depicting one or more objects in one or more scenes, the set of neural networks comprising: a first neural network configured to output one or more detected objects responsive to input 2D image data; a second neural network configured to output one or more geometric embeddings responsive to input based upon one or more point beam proposals generated from the one or more detected objects and the 3D point cloud data; and a third neural network configured to output a regression-based count estimation for the one or more detected objects responsive to input based upon the one or more geometric embeddings; obtaining a set of output regression-based count estimations for the one or more objects in the one or more scenes from the set of neural networks; determining loss based upon the set of output regression-based count estimations for the one or more objects in the one or more scenes and a set of ground truth counts associated with the training data; and updating the set of neural networks via gradient descent using the loss.

A system is provided for training a set of neural networks to infer counts of objects, the system comprising: one or more processors; and one or more hardware storage devices that store instructions that are executable by the one or more processors to configure the system to: provide a set of training data as input to a set of neural networks, the set of training data comprising 3D point cloud data and 2D image data depicting one or more objects in one or more scenes, the set of neural networks comprising: a first neural network configured to output one or more detected objects responsive to input 2D image data; a second neural network configured to output one or more geometric embeddings responsive to input based upon one or more point beam proposals generated from the one or more detected objects and the 3D point cloud data; and a third neural network configured to output a regression-based count estimation for the one or more detected objects responsive to input based upon the one or more geometric embeddings; obtain a set of output regression-based count estimations for the one or more objects in the one or more scenes from the set of neural networks; determine loss based upon the set of output regression-based count estimations for the one or more objects in the one or more scenes and a set of ground truth counts associated with the training data; and update the set of neural networks via gradient descent using the loss.

One or more hardware storage devices are provided that store instructions that are executable by one or more processors of a system to configure the system to: provide a set of training data as input to a set of neural networks, the set of training data comprising 3D point cloud data and 2D image data depicting one or more objects in one or more scenes, the set of neural networks comprising: a first neural network configured to output one or more detected objects responsive to input 2D image data; a second neural network configured to output one or more geometric embeddings responsive to input based upon one or more point beam proposals generated from the one or more detected objects and the 3D point cloud data; and a third neural network configured to output a regression-based count estimation for the one or more detected objects responsive to input based upon the one or more geometric embeddings; obtain a set of output regression-based count estimations for the one or more objects in the one or more scenes from the set of neural networks; determine loss based upon the set of output regression-based count estimations for the one or more objects in the one or more scenes and a set of ground truth counts associated with the training data; and update the set of neural networks via gradient descent using the loss.

### BRIEF DESCRIPTION OF THE DRAWINGS

FIG. 1 illustrates an example setting where objects are densely packed, causing extreme occlusion.

FIG. 2A illustrates a conceptual representation of a count estimation architecture that may comprise or implement various components of the disclosed embodiments.

FIG. 2B illustrates a conceptual representation of a point beam.

FIG. 3 illustrates an example flow diagram depicting acts associated with inferring counts of objects.

FIG. 4 illustrates an example flow diagram depicting acts associated with training a set of neural networks to infer counts of objects.

FIG. 5 illustrates a table depicting summary statistics for datasets used to obtain experimental results.

FIG. 6 illustrates example bird's eye view (BEV) representations applied to point beam proposals.

FIG. 7 illustrates a table of experimental results from evaluation of test datasets using different count estimation methods.

FIG. 8 illustrates a table depicting the effect that point representation has on prediction error.

FIG. 9 depicts a table of experimental results from evaluation of real-world test datasets using the different count estimation methods.

FIG. 10 illustrates an example system that may comprise or implement one or more disclosed embodiments.

### DETAILED DESCRIPTION OF VARIOUS EMBODIMENTS

The inventive concepts of the present disclosure will be described below with reference to embodiments and with reference to the drawings. But the claimed invention is not limited thereto. The drawings described are only schematic and are non-limiting in scope. In the drawings, the size of some of the elements may be exaggerated and not drawn to scale; this is for ease of illustration. The dimensions and relative dimensions do not necessarily correspond to practical embodiments of the invention.

Furthermore, the terms first, second, third and the like may be used for distinguishing between similar elements and not necessarily for describing a sequential or chronological order. The terms are interchangeable under appropriate circumstances and the embodiments of the invention can be practiced in sequences other than those described or illustrated herein.

The terms “topmost,” “upper,” “bottommost,” “lower,” “above,” “below,” and the like in the description and in the claims are also used for purposes of example and are not necessarily used to describe relative positions. These terms are interchangeable under appropriate circumstances and the embodiments of the invention described herein can be practiced in other orientations than described or illustrated herein.

In addition, the various embodiments which may be described as “preferred embodiments” are to be construed as merely illustrative of ways and modes for carrying out the invention and not as limitations on the scope of the invention.

The terms “comprising”, “including”, or “having” as used in the claims should not be interpreted as being limited to the means or steps mentioned thereafter. The terms are to be interpreted as specifying the presence of the stated features, elements, steps or components as referred to, but do not preclude the presence or addition of one or more other features, elements, steps or components, or groups thereof. Thus, the scope of the expression “an apparatus or device comprising means A and B” should not be taken as being limited to an apparatus or device consisting only of components A and B. It is intended that for the purposes of this disclosure, only the parts A and B of the device are specifically mentioned, but the claims should be further construed to include equivalents of these parts.

As indicated hereinabove, automatically identifying and counting densely spaced objects in 3D space is an important problem with many real-world applications, as described for example, in U.S. application Ser. No. 17/501,810, filed at the U.S. Patent and Trademark Office on Oct. 14, 2021, and published as US 2022/0121852 A1, the entire contents of which are herein incorporated by reference.

A system that is able to accurately identify and count objects can be used to streamline physical processes. For example, in physical retail and inventory management, it can be challenging to know how many products are on a shelf at any given time. Auditing of product counts is typically done manually, which can be tedious and time consuming, especially when the number of object classes is large. Other applications of automatic object identification and counting might include estimating agricultural crop yields, where surveyors assess large farmlands and infer counts with sampling and interpolation. In either case, existing methods cannot be easily used to automate the task.

Some existing methods for facilitating object identification and/or counting utilize visual object counting with RGB and RGB-D images. Some techniques involve constructing a convolutional neural network (CNN) architecture that operates on image patches to predict local object counts, which are then refined with a global CNN layer to predict total counts. Other methods leverage CNNs trained to predict density maps, which produce count estimates through density map integration. Some approaches attempt to solve the multi-view crowd counting problem by estimating 3D scene-level density maps.

Some existing methods utilize a lidar-based, remote sensor system to facilitate 3D object counting, relying on handcrafted point-cloud features and a watershed clustering algorithm to determine object counts. Other methods utilize 3D constructions of stereo images, singular value decomposition (SVD), and sphere fitting for fast and accurate grape count inference. Some object classification and/or counting methods employ deep learning architectures that operate on point clouds to learn features on raw points clouds or voxels.

One method utilizes PointNets, along with a 3D viewing Frustum, trained to detect objects in 3D. However, frustum PointNets assume that a single object lies in the viewing frustum, which prevents conventional frustrum PointNets from being usable to facilitate counting of densely packed and/or occluded objects.

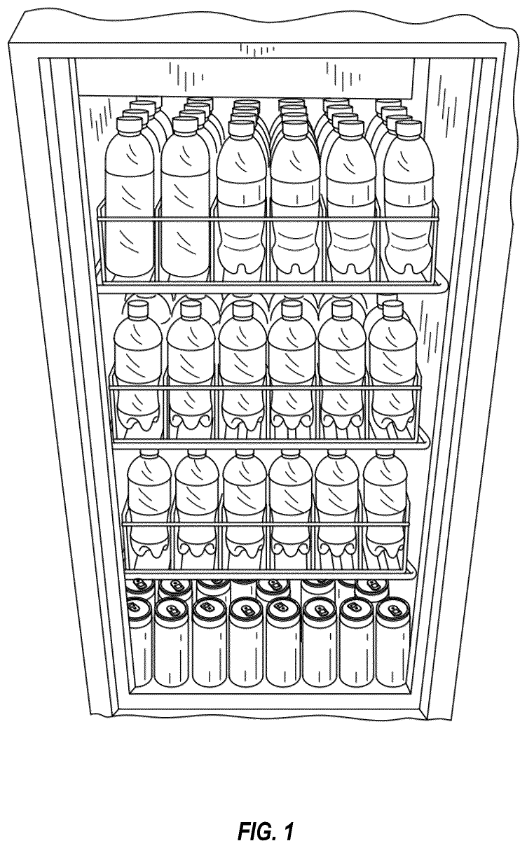

In contrast with existing methods, at least some disclosed embodiments utilize a regression-based deep learning architecture for learning object counts in 3D. At least some disclosed embodiments may be implemented to infer counts of 3D objects that are densely spaced and/or where extreme occlusion is present. FIG. 1 illustrates an example a retail setting (showing beverages within a retail cooler), where objects are densely packed. 3D count inference in such settings is associated with numerous technical challenges. First, the objects of FIG. 1 are positioned in close proximity and are expected to significantly occlude more distant objects (referred to herein as “extreme occlusion”). Such occlusion renders both detection and count inference from RGB images alone intractable because salient features of each occluded object are not clearly visible. Furthermore, in view of such extreme occlusion, simply applying powerful 3D object detectors is likely to yield poor performance. Second, the objects in FIG. 1 are heterogeneous and therefore need to be both classified and counted. Conventional object counting approaches typically assume that all objects in an image or scene belong to the same class (e.g., all target objects are people). Third, there is a lack of benchmark datasets usable for 3D count inference problems (e.g., in view of the high cost of labeling 3D data).

At least some implementations of the present disclosure solve the foregoing problems via a regression-based deep learning architecture that processes multi-sensor data (e.g., 2D image data and 3D point cloud data) to output fine-grained object count estimates. At least some disclosed embodiments utilize a 2D object detector to identify and localize heterogenous objects from images, along with data fusion that occurs by projecting the detections into 3D space (e.g., using the camera pose, camera intrinsic properties, and ray casting from SLAM (simultaneous localization and mapping) output). The point cloud is then segmented into smaller subspaces around the localized objects (such subspaces are referred to herein as “point beams” or “point beam proposals”).

In some implementations, point beam proposals use the shape of a 2D bounding box to facilitate very fine-grained count estimation by reducing the 3D search space to local neighborhoods associated with known objects. Some embodiments employ a PointNet backbone to learn geometric features for each point beam, followed by fully connected layers (e.g., a multilayer perceptron) to predict the total number of objects within the point beam.

The present disclosure includes a discussion of example experimental results, which compare regression-based methods as disclosed herein to state-of-the-art detection-based counting methods. As will be described in more detail hereinafter, the experimental results demonstrate learning counts end-to-end greatly improve object count performance. For instance, implementations of the present disclosure achieved a 3.9% percentage error on a test set, which represents a 33.96% reduction in error compared to the most effective 3D object detector.

The present disclosure also provides a comparison of point beam segmentation to global processing of point clouds. These results indicate that the point beam proposal approach can generally improve performance under extreme occlusion. Furthermore, the present disclosure discusses implementation of principles disclosed herein on a novel, real-world dataset including of 7.8k LiDAR scans of retail shelves. An error 11.01% was achieved, outperforming alternative 3D counting methods.

In one example, for purposes of explanation, a set of n scenes may be characterized as S={sᵢ: 0<i≤n}, where each scene, sᵢ= [symbol] X⁽ⁱ⁾, z⁽ⁱ⁾ [symbol] , is defined as a tuple containing a set of RGB images, X⁽ⁱ⁾={x₁, x₂, . . . }, and a point cloud z⁽ⁱ⁾. A depth sensor (e.g., a LIDAR sensor) is assumed to be co-calibrated with an image sensor (e.g., an RGB camera). A set of m object classes, C={cⱼ:0<j≤m}, is observed across the scenes in S. From the object set, C, an observed set of objects and their counts in each scene sᵢ can be constructed. Observed object counts in scene sᵢ can be represented with y⁽ⁱ⁾, which may comprise a label vector of non-negative values, y⁽ⁱ⁾∈{0, 1, 2, . . . }^{m}, where each component

$${y}_{j}^{( i )} ,$$

denotes the count of class, cⱼ, in scene, sᵢ.

In some implementations, a system learns a function, ƒ(·), that inputs a set of images, X^{(t)}, and a point cloud, z^{(t)}, and outputs the estimated count, ŷ⁽ⁱ⁾, of each class, cⱼ, in scene sᵢ. In vector notation, the learned function may be represented as

$${\hat{y}}^{( i )} = f ( {X}^{( i )} , {z}^{( i )} θ ) \qquad ( 1 )$$

where θ is a vector of parameters (e.g., weights of one or more neural networks).

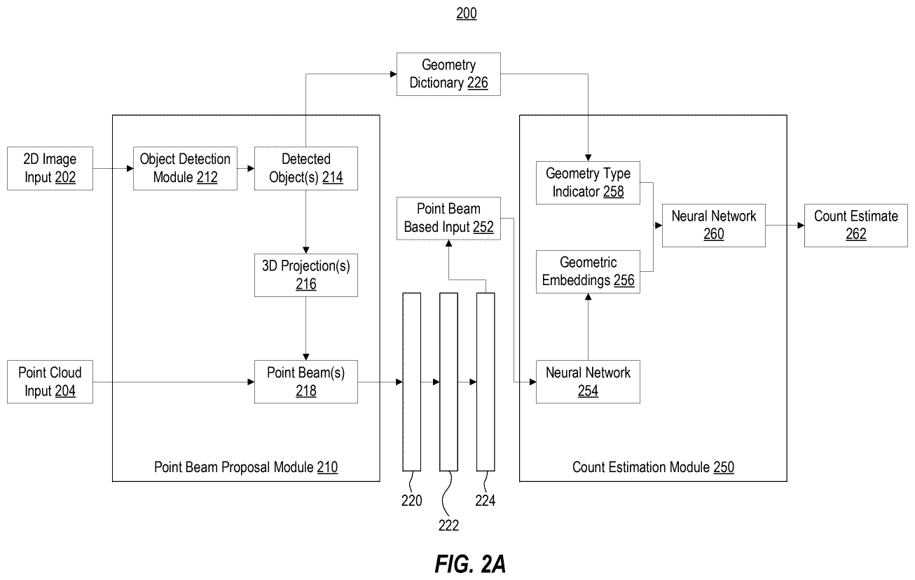

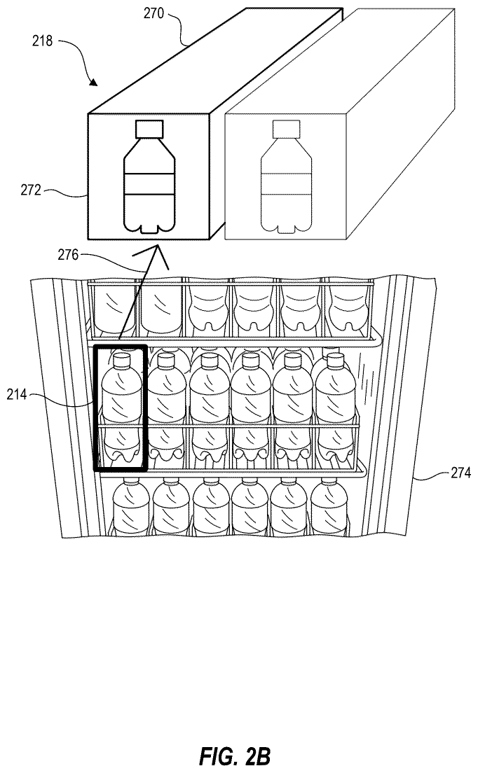

In accordance with the above principles, a multi-modal deep architecture may be utilized to infer counts (e.g., for densely spaced 3D objects, where extreme occlusion is present). FIG. 2A illustrates a conceptual representation of a count estimation architecture 200 that may comprise or implement various components of the disclosed embodiments. In the example of FIG. 2A, the count estimation architecture 200 includes two primary modules: a point beam proposal module 210 and a count estimation module 250.

In some implementations, the point beam proposal module 210 is configured to fuse data from images and point clouds to obtain point beam proposals (or simply “point beams”). A point beam proposal corresponds to a 3D geometry extended from a 2D shape (e.g., a 2D bounding box) associated with a detected object (e.g., an object represented in input imagery). A point beam proposal can indicate a part of a 3D scene where objects are expected to lie and can therefore facilitate regression-based counting of such objects (even where extreme occlusion is present). The count estimation module 250 is configured to process the point beams and output regression-based count estimations. The point beam proposal module 210 and/or the count estimation module 250 may comprise or be in communication with one or more sub-modules, neural networks, and/or other components. One will appreciate, in view of the present disclosure, that the particular components shown in FIG. 2A are provided by way of example only and are not limiting of the principles disclosed herein.

In the example of FIG. 2A, the point beam proposal module 210 is configured to receive 2D image input 202 and point cloud input 204. Images can contain rich information about objects in a 3D scene and can therefore be used for localization and classification. In some instances, the 2D image input 202 includes a set of image frames acquired via a sensor (e.g., a handheld sensor of a user, such as a mobile electronic device that includes a camera). For example, the image frames may comprise keyframes from a video stream that captures the scene that includes one or more objects for which count estimations are desired. The keyframes may be selected from the video stream in accordance with predefined rules (e.g., keyframes may be selected based upon camera pose, change in camera pose, etc.).

To extract 2D object detections from the image set, X⁽ⁱ⁾={x₁, x₂, . . . }, the point beam proposal module 210 may include an object detection module 212 (e.g., a YOLOv5 model or other CNN-based object detection module). The object detection module 212 receives the 2D image input 202 and outputs one or more detected objects 214 (e.g., in the form of granular, fine-grained object classifications).

As indicated in FIG. 2A, 3D projections 216 can be generated for the detected object(s) 214 by projecting a 2D shape (e.g., a 2D bounding box) into 3D space (e.g., via ray casting utilizing camera intrinsic properties and pose data). In some implementations, the 2D shape is projected onto the estimated location (x, y, z) of the corresponding detected object within the scene (e.g., using depth data associated with the image data for the corresponding detected object).

The point cloud input 204 (or other 3D representation) may be acquired utilizing any suitable depth detection methods, such as stereo imaging, time-of-flight imaging, LiDAR, and/or others. In some instances, the point cloud input 204 (or other 3D data) is acquired in parallel with acquisition of the 2D image input 202 (e.g., via SLAM or other methods). Although the present disclosure focuses, in at least some respects, on examples in which LiDAR is utilized to acquire the point cloud data, other methods may be utilized in accordance with the principles disclosed herein.

The 3D projections 216 may be utilized in combination with the point cloud input 204 to generate the point beams 218 (which may be regarded as a focused 3D regressor). FIG. 2B provides a conceptual representation of a point beam 218. For instance, the point beam 218 of FIG. 2B corresponds to a 3D geometry 270 extended from a 2D shape 272 projected into 3D space (e.g., a projection of a 2D bounding box associated with a detected object 214 through an image plane 274 into 3D space, as indicated in FIG. 2B by the arrow 276). In the example of FIG. 2B, the 3D geometry of the point beam 218 comprises a prismatic geometry (e.g., a rectangular prism) formed by extending a 2D bounding box (w, h) along a normal vector (e.g., to a pre-specified depth, d). The normal vector may be computed respect to an image plane (e.g., image plane 274) associated with the detected object(s) 214 and/or projections thereof. As noted herein, a point beam 218 may be associated with 3D points of a point cloud of the scene (e.g., point cloud input 204) that lie within the 3D geometry 270 of the point beam 218 (the 3D points are not shown in FIG. 2B for drawing clarity).

In some instances, point beams have the property that the field of view (or cross-section) remains constant as the distance from the camera (or 2D shape from which the point beam is extended) increases (e.g., in contrast with conventional view frustrum methods, where the field of view or cross-section expands as the distance from the camera or object location increases).

In some implementations, the point beams 218 are used to map each 3D point in the point cloud input 204 to a point beam that covers the 3D positioning of the 3D point. In this regard, each of the point beams 218 may be associated with a respective set of points of the point cloud input 204. In some instances, 3D points that do not lie in a point beam are discarded. The point beams 218 may thus comprise geometric characteristics (e.g., shape, volume) and positioning characteristics (e.g., global coordinates within the 3D scene). As indicated hereinabove, the point beams 218 may provide a basis for generating a regression-based count estimation. For instance, input based upon the point beams 218 may be applied to the count estimation module 250, which may include one or more neural networks for inferring object counts.

The point beams may be represented in various ways, and the representation can impact count estimation accuracy (as described in more detail hereinafter). In the example of FIG. 2A, various data transformations are applied for the point beams 218 to generate input for use with the count estimation module 250. For instance, FIG. 2A depicts an orthogonal rotation operation 220, a mean shift operation 222, and a depth feature calculation operation 224. In some implementations, the orthogonal rotation operation 220 involves rotation of each of the point beams (e.g., about a vertical axis) to become orthogonal to a center axis (e.g., a left-right axis) to give each point beam the same orientation (which may improve rotation invariance). The orthogonal rotation operation 220 may enable generation of point beams for objects in scenes of arbitrary poses and orientations.

In some implementations, the mean shift operation 222 involves subtracting each point in a point beam by the mean of all points in the point beam, resulting in a local coordinate representation for each point in the point beam proposal. The local coordinate representation can facilitate consistent centering and/or scaling. The mean shift operation 222 may improve translation invariance.

In some implementations, the depth feature calculation operation 224 involves calculating a depth feature for each point (of the point cloud) associated with a point beam. Intuitively, the number of objects in a point beam proposal can be correlated with how close to the front or back of the point beam each object is. In one example, to directly model this intuition, depth features for each point in a point beam may be calculated by measuring the distance in a forward dimension to (i) a most distant point within the point beam and (ii) a nearest point in the point beam. For instance, assuming a y forward coordinate space, for each point [symbol] xᵢ, yᵢ, zᵢ [symbol] that is associated (or within) a point beam, depth feature D= [symbol] yₘₐₓ−yᵢ, yₘᵢₙ−yᵢ [symbol] may be calculated.

In the example of FIG. 2A, various components are concatenated to provide input 252 based upon the point beams 218 (e.g., “Point Beam Based Input 252”, as shown in FIG. 2A). For instance, for each point of the point cloud input 204 that is associated with a point beam of the point beams 218, the input 252 may include a concatenation of the global [symbol] x_{g}, y_{g}, z_{g} [symbol] coordinates, the local [symbol] xₗ, yₗ, zₗ [symbol] coordinates (e.g., obtained via the mean shift operation 222), and the depth feature D (e.g., obtained via the depth feature calculation operation 224), thereby forming an 8-channel input point cloud.

To generate count estimation(s), the input 252 may be stacked into a single tensor and processed by the count estimation module 250. As shown in FIG. 2A, the count estimation module 250 may include a neural network 254 configured to process the input 252 to provide geometric embeddings 256 (e.g., a continuous vector representation of abstract features of the geometry). In the example of FIG. 2A, neural network 254 comprises a PointNet model, but other types of processing modules may be utilized in accordance with the present disclosure.

FIG. 2A depicts the geometric embeddings 256 concatenated with a geometry type indicator 258 to form input for processing by a neural network 260 to generate the count estimate(s) 262 (e.g., by arrows combining from the geometry type indicator 258 and the geometric embeddings 256 to form input to the neural network 260 in FIG. 2A). The geometry type indicator 258 may comprise a one-hot vector that denotes geometry type. In some instances, the one-hot vector is generated using a pre-defined geometry dictionary 226 that maps fine-grained object class, ¿ (as represented in the detected objects 214), to coarse geometric type, g. By way of non-limiting example, a fine-grained object class may indicate a specific universal product code (UPC) for a detected object, whereas a coarse geometric type may indicate coarse geometric characteristics, such as object size, volume, etc., which may be shared across multiple object classes. Utilizing the geometry type indicator 258 may thus facilitate dimensionality reduction that reduces the set of candidate classes. One will appreciate, in view of the present disclosure, that dimensionality reduction based upon coarse geometric type may be omitted in some implementations (e.g., where the number of fine-grained object classes is relatively small), instead using the fine-grained object classes in the one-hot tensor.

As noted above, in the example of FIG. 2A, the input based upon the geometric embeddings 256 (e.g., a tensor comprising a concatenation of the geometry type indicators 258 and the geometric embeddings 256) may be provided as input to a neural network 260 to generate the count estimate 262. The neural network 260 may comprise fully connected layers and may take on various forms (e.g., in FIG. 2A, neural network 260 is depicted as a multilayer perceptron (MLP)). In one example, neural network 260 includes 5 fully connected layers with dimensions [512, 256, 64, 64, 64], and ReLU activations and batch normalization may be used after each layer.

In some implementations, the output of the count estimation module 250 is a single scalar. For example, since the point beams-based input 252 can be stacked and passed through the count estimation module 250, the output tensor can have dimensions (B×N×1), where B is the batch size and N is the total number of point beams in each batch. From the output tensor, a tuple [symbol] ĉᵢⱼ, ŷᵢⱼ [symbol] may be obtained for each point beam, which describes the predicted fine-grained class and the total count within each point beam. The predicted counts within each class may then be summed to obtain class-level count estimates.

One simplifying assumption implicit in at least some disclosed embodiments is that occluded objects that fall within a point beam cast by the bounding box plane are assumed to be of the same class as those that are easily visible from an image. This is a reasonable assumption in many applications, such as inventory management crop yield estimation, and/or others.

The components of the count estimation architecture 200 may be trained for end-to-end learning of counts in various ways. In one example, the components of the count estimation architecture are trained utilizing a squared error loss function:

$${ℒ}_{scene} = {\sum }_{j} {( {y}_{j} - {\hat{y}}_{j} )}^{2} \qquad ( 2 )$$

Each scene, sᵢ, may contain a set of kᵢ object detections. Consequently, in some instances, the loss function may comprise the average squared error over a batch of scenes:

$$ℒ = \frac{{\sum }_{i} {\sum }_{j} {( {y}_{i , j} - {\hat{y}}_{i , j} )}^{2}}{N} \qquad ( 3 )$$

where i indexes scene, sᵢ, in a batch, and j indexes each point beam, bⱼ. The denominator, N=Σᵢkᵢ, is the total number of point beams proposed across all the scenes in the batch.

Although not illustrated in FIG. 2A, a count estimation architecture 200 may include an attention module that can be trained on pairwise correlations among point beam proposals and/or count inferences.

The following discussion now refers to a number of methods and method acts that may be performed in accordance with the present disclosure. Although the method acts are shown and/or discussed in a certain order, no particular ordering is required unless specifically stated, or required because an act is dependent on another act being completed prior to the act being performed. Certain embodiments of the present disclosure may omit one or more of the acts described herein.

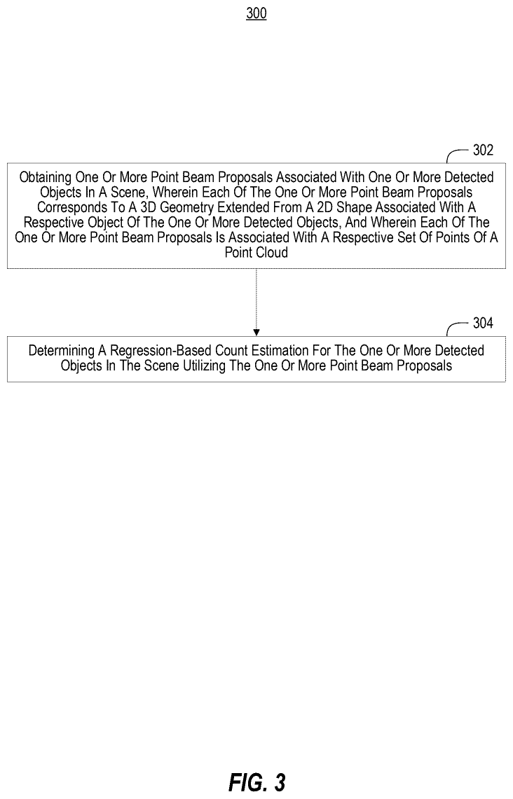

FIG. 3 illustrates an example flow diagram 300 depicting acts associated with inferring counts of objects.

Act 302 of flow diagram 300 includes obtaining one or more point beam proposals (e.g., point beams 218) associated with one or more detected objects in a scene (e.g., detected objects 214), wherein each of the one or more point beam proposals corresponds to a 3D geometry extended from a 2D shape associated with a respective object of the one or more detected objects, and wherein each of the one or more point beam proposals is associated with a respective set of points of a point cloud (e.g., point cloud input 204). In some instances, the one or more detected objects in the scene are detected utilizing one or more 2D images of the scene (e.g., 2D image input 202). The one or more detected objects in the scene may be detected by utilizing the one or more 2D images as input to a convolutional neural network (CNN) based object detection module (e.g., object detection module 212). In some instances, the one or more 2D images comprise one or more keyframes from a video stream, which may be selected from the video stream based upon camera pose and/or change in camera pose.

In some implementations, for each of the one or more point beam proposals, the 3D geometry comprises a prismatic geometry computed by extending the 2D shape along a normal vector. The 2D shape may comprise a 2D bounding box, and/or the prismatic geometry may comprise a rectangular prism. In some instances, the normal vector is determined relative to an image plane associated with the respective object. In some implementations, for each of the one or more point beam proposals, the 2D shape is projected onto an estimated location of the respective object of the one or more detected objects within the scene (e.g., forming 3D projections 216). For each of the one or more point beam proposals, the 2D shape may be projected utilizing depth data associated with at least part of the scene. In some instances, the point cloud is acquired in parallel with acquisition of one or more 2D images of the scene.

Act 304 of flow diagram 300 includes determining a regression-based count estimation (e.g., count estimate 262) for the one or more detected objects in the scene utilizing the one or more point beam proposals. In some implementations, determining the regression-based count estimation comprises applying input based upon the one or more point beam proposals (e.g., input 252) to one or more neural networks. The input based upon the one or more point beam proposals may be determined by applying one or more data transformations for the one or more point beam proposals. In some instances, the one or more data transformations comprise an orthogonal rotation operation (e.g., orthogonal rotation operation 220) that causes each of the one or more point beam proposals to become orthogonal to a center axis. In some instances, the one or more data transformations comprise a mean shift operation (e.g., mean shift operation 222) that provides a local coordinate representation for each point associated with a point beam proposal of the one or more point beam proposals. In some instances, the one or more data transformations comprise a depth feature calculation operation (e.g., depth feature calculation operation 224) that provides a depth feature for each point associated with a point beam proposal of the one or more point beam proposals.

The input based upon the one or more point beam proposals (e.g., input 252) may comprise, for each point associated with a point beam proposal of the one or more point beam proposals, a concatenation of (i) a global coordinate representation, (ii) the local coordinate representation, and (iii) the depth feature. The one or more neural networks may comprise a first neural network (e.g., neural network 254, which may comprise a PointNet model) configured to receive the input (e.g., input 252) based upon the one or more point beam proposals and output one or more geometric embeddings (e.g., geometric embeddings 256).

In some implementations, the one or more neural networks comprises a second neural network (e.g., neural network 260) configured to receive input based upon the one or more geometric embeddings and output the regression-based count estimation (e.g., count estimate 262) for the one or more detected objects in the scene. In some instances, the input based upon the one or more geometric embeddings comprises a concatenation of (i) the one or more geometric embeddings and (ii) a geometry type indicator (e.g., geometry type indicator 258). The geometry type indicator may comprise a one-hot vector denoting geometry type. The one-hot vector may be generated utilizing a pre-defined geometry dictionary that maps detected object class for the one or more detected objects to geometry type. The second neural network may comprise a multilayer perceptron (MLP).

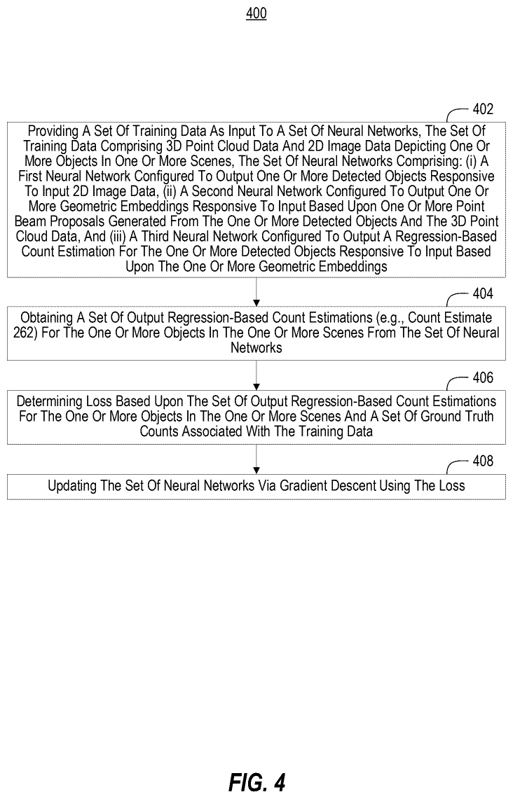

FIG. 4 illustrates an example flow diagram 400 depicting acts associated with training a set of neural networks to infer counts of objects.

Act 402 of flow diagram 400 includes providing a set of training data as input to a set of neural networks (e.g., neural networks of point beam proposal module 210 and count estimation module 250), the set of training data comprising 3D point cloud data (e.g., point cloud input 204) and 2D image data (e.g., 2D image input 202) depicting one or more objects in one or more scenes, the set of neural networks comprising: (i) a first neural network configured to output one or more detected objects responsive to input 2D image data, (ii) a second neural network configured to output one or more geometric embeddings responsive to input based upon one or more point beam proposals (e.g., point beams 218) generated from the one or more detected objects and the 3D point cloud data, and (iii) a third neural network configured to output a regression-based count estimation for the one or more detected objects responsive to input based upon the one or more geometric embeddings (e.g., geometric embeddings 256).

In some instances, the first neural network comprises a convolutional neural network (CNN) based object detection module (e.g., object detection module 212). In some implementations, each of the one or more point beam proposals corresponds to a 3D geometry extended from a 2D shape associated with a respective object of the one or more detected objects, and each of the one or more point beam proposals is associated with a respective set of points of the 3D point cloud data. For each of the one or more point beam proposals, the 3D geometry may comprise a prismatic geometry computed by extending the 2D shape along a normal vector. In some instances, the normal vector is determined relative to an image plane associated with the respective object. In some instances, the 2D shape comprises a 2D bounding box, and/or the prismatic geometry comprises a rectangular prism. For each of the one or more point beam proposals, the 2D shape is projected utilizing depth data associated with at least part of the scene.

In some implementations, the input based upon the one or more point beam proposals (e.g., input 252) is determined by applying one or more data transformations for the one or more point beam proposals. In some instances, the one or more data transformations comprise an orthogonal rotation operation (e.g., orthogonal rotation operation 220) that causes each of the one or more point beam proposals to become orthogonal to a center axis. In some instances, the one or more data transformations comprise a mean shift operation (e.g., mean shift operation 222) that provides a local coordinate representation for each point associated with a point beam proposal of the one or more point beam proposals. In some instances, the one or more data transformations comprise a depth feature calculation operation (e.g., depth feature calculation operation 224) that provides a depth feature for each point associated with a point beam proposal of the one or more point beam proposals.

The input based upon the one or more point beam proposals (e.g., input 252) may comprise, for each point associated with a point beam proposal of the one or more point beam proposals, a concatenation of (i) a global coordinate representation, (ii) the local coordinate representation, and (iii) the depth feature. The second neural network may comprise a PointNet model.

In some instances, the input based upon the one or more geometric embeddings comprises a concatenation of (i) the one or more geometric embeddings and (ii) a geometry type indicator (e.g., geometry type indicator 258). The geometry type indicator may comprise a one-hot vector denoting geometry type. The one-hot vector may be generated utilizing a pre-defined geometry dictionary that maps detected object class for the one or more detected objects to geometry type. In some instances, the third neural network comprises a multilayer perceptron (MLP).

Act 404 of flow diagram 400 includes obtaining a set of output regression-based count estimations (e.g., count estimate 262) for the one or more objects in the one or more scenes from the set of neural networks.

Act 406 of flow diagram 400 includes determining loss based upon the set of output regression-based count estimations for the one or more objects in the one or more scenes and a set of ground truth counts associated with the training data. In some instances, the loss comprises a squared error loss (e.g., see Equations 2 and/or 3).

Act 408 of flow diagram 400 includes updating the set of neural networks via gradient descent using the loss. In some implementations, the set of neural networks further comprises an attention module, and updating the set of neural networks may further comprise updating the attention module.

The following discussion relates to various example implementations and test/experimental results. One will appreciate, in view of the present disclosure, that the particular implementation details discussed below are not limiting of the principles described herein.

In some instances, point clouds have a variable size (e.g., due to the variable number of points captured by via LiDAR). Additionally, each scene, sᵢ, may contain a variable number of kᵢ object detections. Both of these issues can contribute to difficulty in mini-batch training with stacked tensors. To solve this problem, a maximum points parameter, M, is imposed on each point beam in the following experiments. If the number of points that fell in a point beam is greater than M, the points were downsampled to be of size M. Otherwise, the point beam tensor was zero-padded. In the following experiments, M=1024. This operation produced tensors of a fixed size that can be easily stacked into a mini batch. The resulting point cloud tensor had dimensions B×N×M×C, where B is the batch size, and C is the number of channels. An image resolution of 640×480 was used in the 2D detection layer.

Each entire scene was processed by mean shifting and transforming into the unit ball by dividing each point by the maximum norm of all the points. This put all the point clouds at the origin with a normalized point cloud range in [−1, 1] in [symbol] x, y, z [symbol] . The normalized point clouds were then fed into the point beam proposal layer. When proposing point beams, two additional hyperparameters were introduced to control the shape and size of the beams. First, E, perturbs the dimensions of the 2D bounding box plane: [symbol] w*(1+ϵ), h*(1+ϵ [symbol] . This allows the count estimation architecture to capture points around the boundary of the target object. Second, δ, determines the depth of each beam. In the following experiments, ϵ=0.05 and δ=0.6.

Experiments were performed on two datasets, one synthetic and one real-world. Both of the datasets contain scenes of beverages on shelves. A dataset called 3DBev24k was used, which includes scenes built using the 3D graphics software called Blender. The scenes of 3DBev24k were manually constructed of retail shelves with object placement similar to real-world scenes. Variance was added to the data during simulation by 1) randomizing LiDAR physics parameters 2) masking objects out of the scene. For each

scene, the simulation process outputs a point cloud using Blensor, and a variety of annotations including class counts, bounding boxes, and semantic segmentation labels. The classes of the objects are organized hierarchically and correspond to products typically seen in beverage retail. For each object, a fine-grained class was provided (e.g., “coca cola 20 oz bottle”) and a geometric class (e.g., “20ozBottle”). A canonical train/test split was also defined with 18,984 train examples and 4,820 test examples.

Experiments were also performed with a proprietary real-world dataset to evaluate the effectiveness of the count estimation architecture 200 on complicated, physical scenes. The real-world dataset included 7,882 annotated examples. Using a custom iOS mobile application on iPhone 12/13 and iPad Pro 4th generation with built-in LiDAR, images and point clouds were captured of real-world scenes with strong occlusion in a retail setting. These scenes are also annotated with fine-grained class counts by experts. Due to the difficulty of labelling point clouds of very crowded scenes with 3D bounding

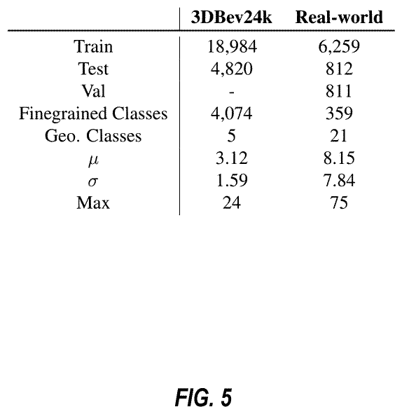

boxes, the experimental results below omit a comparison with detection-based counting methods on the real-world data. FIG. 5 illustrates a table of summary statistics for 3DBev24k and the real-world dataset.

The count estimation architecture 200 and various detection-based count methods were evaluated using Mean Absolute Error (MAE), Mean Absolute Percentage Error (MAPE), and Mean-squared Error (MSE). In all three metrics, lower values correspond to lower error and more accurate count estimation.

One 2D, and multiple 3D object detectors were trained to classify and localize objects in each scene. YOLOv5 is trained to detect objects from images only. The 3D detectors are trained to detect each of the geometric types from point clouds. We compare the count estimation architecture 200 to PIXOR, SECOND, PointPillars, and VoteNet. For each object detector, the locations of each object were estimated and summed over the bounding boxes to get a per-class count.

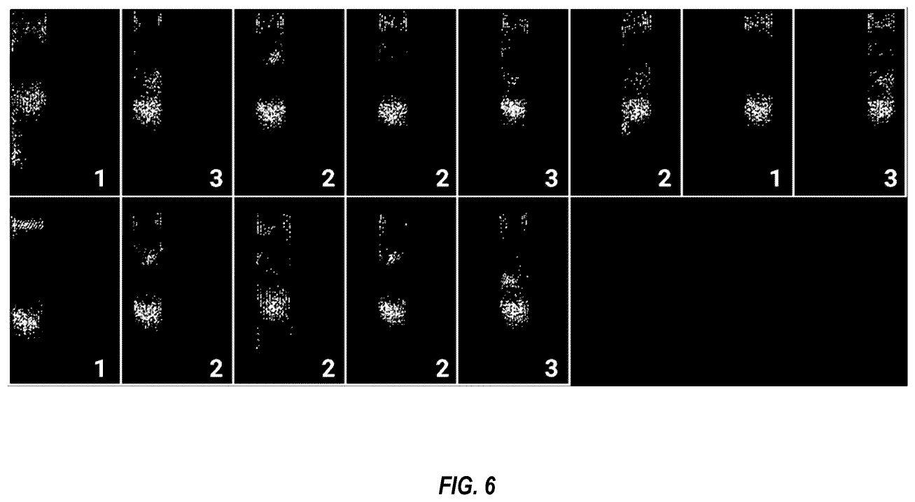

In addition to the count estimation architecture, a novel pipeline for using 2D convolutions as regressors was implemented and tested. Each point beam proposal was projected to a 200×200 bird's eye view (BEV) image with a resolution parameter of 0.01 (see FIG. 6, showing separate BEV point beam projections, along with ground truth count). The BEV point cloud representation can intuitively simplify the counting problem into an easier perceptual problem (counting basic shapes such as rings), and can facilitate the use of mature 2D CNN architectures to estimate counts. Four baseline CNNs were trained on the bird's eye view projections of each point beam proposal: VGG-16, ResNet-18, MobileNetV2, and YOLOv5.

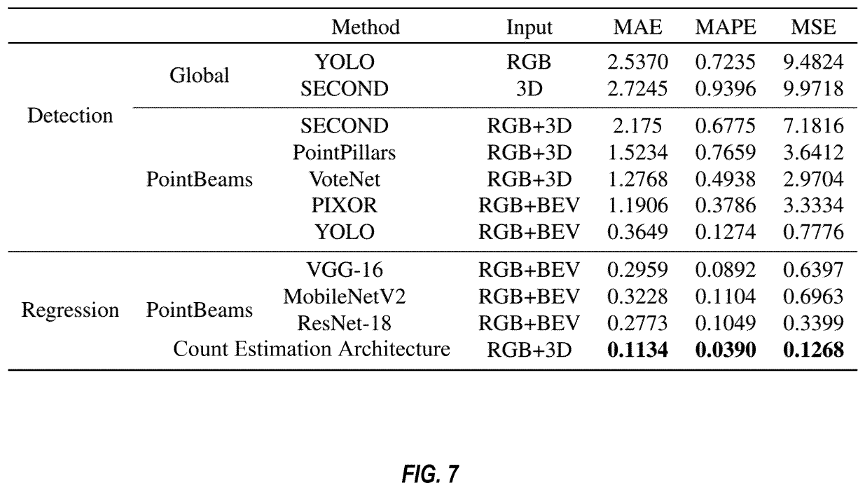

FIG. 7 depicts a table of experimental results from evaluation of test datasets using the different count estimation methods. Various primary observations are evident from the results depicted in FIG. 7. First, in all cases, regression-based methods significantly outperformed 3D detection-based methods. Even the weakest regressor, a MobileNetV2 applied to a bird's eye of view projection, also outperformed PIXOR, the most effective 3D object detector. Interestingly the YOLOv5 model trained on the BEV images dramatically outperformed the 3D detectors, suggesting the effective representation of BEV images. The count estimation architecture 200 of the present disclosure yielded the best performance of all, outperforming PIXOR by 33.96% and VGG-16 by 5.01% in MAPE. Second, FIG. 7 suggests that full 3D is generally better than a BEV image when doing regression. Of the methods tested, the count estimation architecture 200 is the only regression method that leverages full 3D information from the point clouds and reduces MAPE by 7.14%-5.01% compared to the BEV regressors.

A SECOND detector on the global point cloud (no point beams) was trained, and the 3D geometric classes were matched to the fine-grained classes from the images using a nearest neighbors method. Both YOLO and SECOND with point beams yielded much more accuracy than one trained on the full point cloud. Due to vertical occlusion, PointPillars and PIXOR were not applied to the global point cloud.

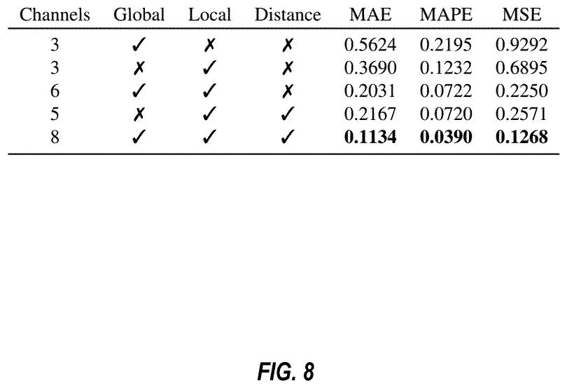

The experiments indicate that the representation of points within each point beam affects count estimation accuracy. FIG. 8 illustrates a table depicting the effect that point representation has on prediction error. FIG. 8 indicates that normalizing the point cloud within each point beam by subtracting the centroid (local) has a large effect on error reduction. The normalization creates a canonical subspace across all point beams and improves translation invariance. FIG. 8 also indicates another large effect when the global and local coordinates are used together. FIG. 8 furthermore indicates another modest error reduction when using the depth features. FIG. 8 indicates that the 8 channel point representation allows the model to make reasonable predictions even in difficult cases where objects are extremely occluded and very few points cover some objects. The CNN-based regressors discussed herein have no mechanism to handle such cases.

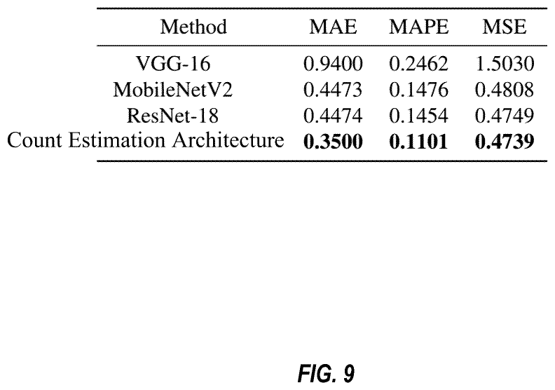

FIG. 9 depicts a table of experimental results from evaluation of real-world test datasets using the different count estimation methods. FIG. 9 indicates that the count estimation architecture 200 of the present disclosure outperforms the BEV-based regression methods across all three evaluation criteria. In particular, the count estimation architecture demonstrates significant performance increase in the average case (MAE, MAPE), and yields a 3.5% reduction in MAPE compared to ResNet. While still superior, the reduction in MSE is slightly lower compared to ResNet and MobileNet.

The foregoing results show that the count estimation architecture 200 of the present disclosure significantly outperforms state-of-the-art 3D object detectors and provides superior performance in real-world settings.

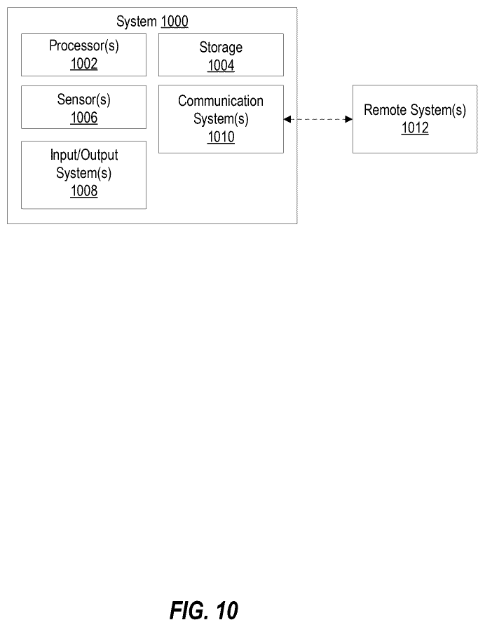

FIG. 10 illustrates example components of a system 1000 that may comprise or implement aspects of one or more disclosed embodiments. For example, FIG. 10 illustrates an implementation in which the system 1000 includes processor(s) 1002, storage 1004, sensor(s) 1006, I/O system(s) 1008, and communication system(s) 1010. Although FIG. 10 illustrates a system 1000 as including particular components, one will appreciate, in view of the present disclosure, that a system 1000 may comprise any number of additional or alternative components.

The processor(s) 1002 may comprise one or more sets of electronic circuitries that include any number of logic units, registers, and/or control units to facilitate the execution of computer-readable instructions (e.g., instructions that form a computer program). Such computer-readable instructions may be stored within storage 1004. The storage 1004 may comprise physical system memory and may be volatile, non-volatile, or some combination thereof. Furthermore, storage 1004 may comprise local storage, remote storage (e.g., accessible via communication system(s) 1010 or otherwise), or some combination thereof. Additional details related to processors (e.g., processor(s) 1002) and computer storage media (e.g., storage 1004) will be provided hereinafter.

As will be described in more detail, the processor(s) 1002 may be configured to execute instructions stored within storage 1004 to perform certain actions. In some instances, the actions may rely at least in part on communication system(s) 1010 for receiving data from remote system(s) 1012, which may include, for example, separate systems or computing devices, sensors, and/or others. The communications system(s) 1010 may comprise any combination of software or hardware components that are operable to facilitate communication between on-system components/devices and/or with off-system components/devices. For example, the communications system(s) 1010 may comprise ports, buses, or other physical connection apparatuses for communicating with other devices/components. Additionally, or alternatively, the communications system(s) 1010 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 10 illustrates that a system 1000 may comprise or be in communication with sensor(s) 1006. Sensor(s) 1006 may comprise any device for capturing or measuring data representative of perceivable phenomenon. By way of non-limiting example, the sensor(s) 1006 may comprise one or more image sensors, microphones, thermometers, barometers, magnetometers, accelerometers, gyroscopes, and/or others.

Furthermore, FIG. 10 illustrates that a system 1000 may comprise or be in communication with I/O system(s) 1008. I/O system(s) 1008 may include any type of input or output device such as, by way of non-limiting example, a display, a touch screen, a mouse, a keyboard, a controller, and/or others, without limitation.

Embodiments of the present disclosure may comprise or utilize a special-purpose or general-purpose computer system, as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media and may comprise physical computer storage media or hardware storage devices. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be included within or accessed and executed by a controller, a general-purpose, or a special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” may be defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions may comprise, for example, instructions and data which, when executed by one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The disclosure of the present application may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The disclosure of the present application may also be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Certain terms are used throughout the description and claims to refer to particular methods, features, or components. As those having ordinary skill in the art will appreciate, different persons may refer to the same methods, features, or components by different names. This disclosure does not intend to distinguish between methods, features, or components that differ in name but not function. The figures are not necessarily drawn to scale. Certain features and components herein may be shown in exaggerated scale or in somewhat schematic form and some details of conventional elements may not be shown or described in interest of clarity and conciseness.

Although various example embodiments have been described in detail herein, many modifications are possible in the example embodiments without materially departing from the concepts of present disclosure. Accordingly, any such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scopes of the disclosure and the appended claims. Each addition, deletion, and modification to the embodiments that falls within the meaning and scope of the claims is to be embraced by the claims.

Certain embodiments and features may have been described using a set of numerical upper limits and a set of numerical lower limits. Ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. Any numerical value is “about” or “approximately” the indicated value, and takes into account experimental error and variations that would be expected by a person having ordinary skill in the art.

This disclosure provides various examples, embodiments, and features which, unless expressly stated or which would be mutually exclusive, should be understood to be combinable with other examples, embodiments, or features described herein.

In addition to the above, further embodiments and examples include the following:
1. A system and/or method for inferring counts of objects and/or training one or more modules to infer counts of objects, as shown and/or described herein.
2. A system for inferring counts of objects, the system comprising: one or more processors; and one or more hardware storage devices that store instructions that are executable by the one or more processors to configure the system to: obtain one or more point beam proposals associated with one or more detected objects in a scene, wherein each of the one or more point beam proposals corresponds to a 3D geometry extended from a 2D shape associated with a respective object of the one or more detected objects, and wherein each of the one or more point beam proposals is associated with a respective set of points of a point cloud; and determine a regression-based count estimation for the one or more detected objects in the scene utilizing the one or more point beam proposals.
3. The system of 2, wherein the one or more detected objects in the scene are detected utilizing one or more 2D images of the scene.
4. The system of 3, wherein the one or more detected objects in the scene are detected by utilizing the one or more 2D images as input to a convolutional neural network (CNN) based object detection module.
5. The system of any one or a combination of one or more of 3-4, wherein the one or more 2D images comprise one or more keyframes from a video stream.
6. The system of 5, wherein the one or more keyframes are selected from the video stream based upon camera pose and/or change in camera pose.
7. The system of any one or a combination of one or more of 2-6, wherein, for each of the one or more point beam proposals, the 3D geometry comprises a prismatic geometry computed by extending the 2D shape along a normal vector.
8. The system of 7, wherein the 2D shape comprises a 2D bounding box, and/or wherein the prismatic geometry comprises a rectangular prism.
9. The system of any one or a combination of one or more of 7-8, wherein the normal vector is determined relative to an image plane associated with the respective object.
10. The system of any one or a combination of one or more of 7-9, wherein, for each of the one or more point beam proposals, the 2D shape is projected onto an estimated location of the respective object of the one or more detected objects within the scene.
11. The system of 10, wherein, for each of the one or more point beam proposals, the 2D shape is projected utilizing depth data associated with at least part of the scene.
12. The system of 11, wherein the point cloud is acquired in parallel with acquisition of one or more 2D images of the scene.
13. The system of any one or a combination of one or more of 2-12, wherein determining the regression-based count estimation comprises applying input based upon the one or more point beam proposals to one or more neural networks.
14. The system of 13, wherein the input based upon the one or more point beam proposals is determined by applying one or more data transformations for the one or more point beam proposals.
15. The system of 14, wherein the one or more data transformations comprise an orthogonal rotation operation that causes each of the one or more point beam proposals to become orthogonal to a center axis.
16. The system of 15, wherein the one or more data transformations comprise a mean shift operation that provides a local coordinate representation for each point associated with a point beam proposal of the one or more point beam proposals.
17. The system of 16, wherein the one or more data transformations comprise a depth feature calculation operation that provides a depth feature for each point associated with a point beam proposal of the one or more point beam proposals.
18. The system of 17, wherein the input based upon the one or more point beam proposals comprises, for each point associated with a point beam proposal of the one or more point beam proposals, a concatenation of (i) a global coordinate representation, (ii) the local coordinate representation, and (iii) the depth feature.
19. The system of 18, wherein the one or more neural networks comprises a first neural network configured to receive the input based upon the one or more point beam proposals and output one or more geometric embeddings.
20. The system of 19, wherein the first neural network comprises a PointNet model.
21. The system of any one or a combination of one or more of 19-20, wherein the one or more neural networks comprises a second neural network configured to receive input based upon the one or more geometric embeddings and output the regression-based count estimation for the one or more detected objects in the scene.
22. The system of 21, wherein the input based upon the one or more geometric embeddings comprises a concatenation of (i) the one or more geometric embeddings and (ii) a geometry type indicator.
23. The system of 22, wherein the geometry type indicator comprises a one-hot vector denoting geometry type.
24. The system of 23, wherein the one-hot vector is generated utilizing a pre-defined geometry dictionary that maps detected object class for the one or more detected objects to geometry type.
25. The system of any one or a combination of one or more of 21-24, wherein the second neural network comprises a multilayer perceptron (MLP).
26. A system for training a set of neural networks to infer counts of objects, the system comprising: one or more processors; and one or more hardware storage devices that store instructions that are executable by the one or more processors to configure the system to: provide a set of training data as input to a set of neural networks, the set of training data comprising 3D point cloud data and 2D image data depicting one or more objects in one or more scenes, the set of neural networks comprising: a first neural network configured to output one or more detected objects responsive to input 2D image data; a second neural network configured to output one or more geometric embeddings responsive to input based upon one or more point beam proposals generated from the one or more detected objects and the 3D point cloud data; and a third neural network configured to output a regression-based count estimation for the one or more detected objects responsive to input based upon the one or more geometric embeddings; obtain a set of output regression-based count estimations for the one or more objects in the one or more scenes from the set of neural networks; determine loss based upon the set of output regression-based count estimations for the one or more objects in the one or more scenes and a set of ground truth counts associated with the training data; and update the set of neural networks via gradient descent using the loss.
27. The system of 26, wherein the loss comprises a squared error loss.
28. The system of any one or a combination of one or more of 26-27, wherein the set of neural networks further comprises an attention module, and wherein updating the set of neural networks further comprises updating the attention module.
29. The system of any one or a combination of one or more of 26-28, wherein the first neural network comprises a convolutional neural network (CNN) based object detection module.
30. The system of any one or a combination of one or more of 26-29, wherein each of the one or more point beam proposals corresponds to a 3D geometry extended from a 2D shape associated with a respective object of the one or more detected objects, and wherein each of the one or more point beam proposals is associated with a respective set of points of the 3D point cloud data.
31. The system of 30, wherein, for each of the one or more point beam proposals, the 3D geometry comprises a prismatic geometry computed by extending the 2D shape along a normal vector.
32. The system of 31, wherein the 2D shape comprises a 2D bounding box, and/or wherein the prismatic geometry comprises a rectangular prism.
33. The system of any one or a combination of one or more of 31-32, wherein the normal vector is determined relative to an image plane associated with the respective object.
34. The system of any one or a combination of one or more of 31-33, wherein, for each of the one or more point beam proposals, the 2D shape is projected utilizing depth data associated with at least part of the scene.
35. The system of any one or a combination of one or more of 26-34, wherein the input based upon the one or more point beam proposals is determined by applying one or more data transformations for the one or more point beam proposals.
36. The system of 35, wherein the one or more data transformations comprise an orthogonal rotation operation that causes each of the one or more point beam proposals to become orthogonal to a center axis.
37. The system of 36, wherein the one or more data transformations comprise a mean shift operation that provides a local coordinate representation for each point associated with a point beam proposal of the one or more point beam proposals.
38. The system of any one or a combination of one or more of 37, wherein the one or more data transformations comprise a depth feature calculation operation that provides a depth feature for each point associated with a point beam proposal of the one or more point beam proposals.
39. The system of 38, wherein the input based upon the one or more point beam proposals comprises, for each point associated with a point beam proposal of the one or more point beam proposals, a concatenation of (i) a global coordinate representation, (ii) the local coordinate representation, and (iii) the depth feature.
40. The system of any one or a combination of one or more of 26-39, wherein the second neural network comprises a PointNet model.
41. The system of any one or a combination of one or more of 26-40, wherein the input based upon the one or more geometric embeddings comprises a concatenation of (i) the one or more geometric embeddings and (ii) a geometry type indicator.
42. The system of 41, wherein the geometry type indicator comprises a one-hot vector denoting geometry type.
43. The system of 42, wherein the one-hot vector is generated utilizing a pre-defined geometry dictionary that maps detected object class for the one or more detected objects to geometry type.
44. The system of any one or a combination of one or more of 26-43, wherein the third neural network comprises a multilayer perceptron (MLP).
45. One or more hardware storage devices that store instructions that are executable by one or more processors of a system to configure the system to: obtain one or more point beam proposals associated with one or more detected objects in a scene, wherein each of the one or more point beam proposals corresponds to a 3D geometry extended from a 2D shape associated with a respective object of the one or more detected objects, and wherein each of the one or more point beam proposals is associated with a respective set of points of a point cloud; and determine a regression-based count estimation for the one or more detected objects in the scene utilizing the one or more point beam proposals.
46. The one or more hardware storage devices of 45, wherein the one or more detected objects in the scene are detected utilizing one or more 2D images of the scene.
47. The one or more hardware storage devices of 46, wherein the one or more detected objects in the scene are detected by utilizing the one or more 2D images as input to a convolutional neural network (CNN) based object detection module.
48. The one or more hardware storage devices of any one of 46-47, wherein the one or more 2D images comprise one or more keyframes from a video stream.
49. The one or more hardware storage devices of 48, wherein the one or more keyframes are selected from the video stream based upon camera pose and/or change in camera pose.
50. The one or more hardware storage devices of any one or a combination of one or more of 45-49, wherein, for each of the one or more point beam proposals, the 3D geometry comprises a prismatic geometry computed by extending the 2D shape along a normal vector.
51. The one or more hardware storage devices of 50, wherein the 2D shape comprises a 2D bounding box, and/or wherein the prismatic geometry comprises a rectangular prism.
52. The one or more hardware storage devices of any one or a combination of one or more of 50-51, wherein the normal vector is determined relative to an image plane associated with the respective object.
53. The one or more hardware storage devices of any one or a combination of one or more of 50-52, wherein, for each of the one or more point beam proposals, the 2D shape is projected onto an estimated location of the respective object of the one or more detected objects within the scene.
54. The one or more hardware storage devices of 53, wherein, for each of the one or more point beam proposals, the 2D shape is projected utilizing depth data associated with at least part of the scene.
55. The one or more hardware storage devices of 54, wherein the point cloud is acquired in parallel with acquisition of one or more 2D images of the scene.
56. The one or more hardware storage devices of any one or a combination of one or more of 45-55, wherein determining the regression-based count estimation comprises applying input based upon the one or more point beam proposals to one or more neural networks.
57. The one or more hardware storage devices of 56, wherein the input based upon the one or more point beam proposals is determined by applying one or more data transformations for the one or more point beam proposals.
58. The one or more hardware storage devices of 57, wherein the one or more data transformations comprise an orthogonal rotation operation that causes each of the one or more point beam proposals to become orthogonal to a center axis.
59. The one or more hardware storage devices of 58, wherein the one or more data transformations comprise a mean shift operation that provides a local coordinate representation for each point associated with a point beam proposal of the one or more point beam proposals.
60. The one or more hardware storage devices of 59, wherein the one or more data transformations comprise a depth feature calculation operation that provides a depth feature for each point associated with a point beam proposal of the one or more point beam proposals.
61. The one or more hardware storage devices of 60, wherein the input based upon the one or more point beam proposals comprises, for each point associated with a point beam proposal of the one or more point beam proposals, a concatenation of (i) a global coordinate representation, (ii) the local coordinate representation, and (iii) the depth feature.
62. The one or more hardware storage devices of 61, wherein the one or more neural networks comprises a first neural network configured to receive the input based upon the one or more point beam proposals and output one or more geometric embeddings.
63. The one or more hardware storage devices of 62, wherein the first neural network comprises a PointNet model.
64. The one or more hardware storage devices of any one or a combination of one or more of 62-63, wherein the one or more neural networks comprises a second neural network configured to receive input based upon the one or more geometric embeddings and output the regression-based count estimation for the one or more detected objects in the scene.
65. The one or more hardware storage devices of 64, wherein the input based upon the one or more geometric embeddings comprises a concatenation of (i) the one or more geometric embeddings and (ii) a geometry type indicator.
66. The one or more hardware storage devices of 65, wherein the geometry type indicator comprises a one-hot vector denoting geometry type.
67. The one or more hardware storage devices of 66, wherein the one-hot vector is generated utilizing a pre-defined geometry dictionary that maps detected object class for the one or more detected objects to geometry type.
68. The one or more hardware storage devices of any one or a combination of one or more of 64-67, wherein the second neural network comprises a multilayer perceptron (MLP).
69. One or more hardware storage devices that store instructions that are executable by one or more processors of a system to configure the system to: provide a set of training data as input to a set of neural networks, the set of training data comprising 3D point cloud data and 2D image data depicting one or more objects in one or more scenes, the set of neural networks comprising: a first neural network configured to output one or more detected objects responsive to input 2D image data; a second neural network configured to output one or more geometric embeddings responsive to input based upon one or more point beam proposals generated from the one or more detected objects and the 3D point cloud data; and a third neural network configured to output a regression-based count estimation for the one or more detected objects responsive to input based upon the one or more geometric embeddings; obtain a set of output regression-based count estimations for the one or more objects in the one or more scenes from the set of neural networks; determine loss based upon the set of output regression-based count estimations for the one or more objects in the one or more scenes and a set of ground truth counts associated with the training data; and update the set of neural networks via gradient descent using the loss.
70. The one or more hardware storage devices of 69, wherein the loss comprises a squared error loss.
71. The one or more hardware storage devices of any one or a combination of one or more of 69-70, wherein the set of neural networks further comprises an attention module, and wherein updating the set of neural networks further comprises updating the attention module.
72. The one or more hardware storage devices of any one or a combination of one or more of 69-71, wherein the first neural network comprises a convolutional neural network (CNN) based object detection module.
73. The one or more hardware storage devices of any one or a combination of one or more of 69-72, wherein each of the one or more point beam proposals corresponds to a 3D geometry extended from a 2D shape associated with a respective object of the one or more detected objects, and wherein each of the one or more point beam proposals is associated with a respective set of points of the 3D point cloud data.
74. The one or more hardware storage devices of 73, wherein, for each of the one or more point beam proposals, the 3D geometry comprises a prismatic geometry computed by extending the 2D shape along a normal vector.
75. The one or more hardware storage devices of 74, wherein the 2D shape comprises a 2D bounding box, and/or wherein the prismatic geometry comprises a rectangular prism.
76. The one or more hardware storage devices of any one or a combination of one or more of 74-75, wherein the normal vector is determined relative to an image plane associated with the respective object.
77. The one or more hardware storage devices of any one or a combination of one or more of 74-76, wherein, for each of the one or more point beam proposals, the 2D shape is projected utilizing depth data associated with at least part of the scene.
78. The one or more hardware storage devices of any one or a combination of one or more of 69-77, wherein the input based upon the one or more point beam proposals is determined by applying one or more data transformations for the one or more point beam proposals.
79. The one or more hardware storage devices of 78, wherein the one or more data transformations comprise an orthogonal rotation operation that causes each of the one or more point beam proposals to become orthogonal to a center axis.
80. The one or more hardware storage devices of 79, wherein the one or more data transformations comprise a mean shift operation that provides a local coordinate representation for each point associated with a point beam proposal of the one or more point beam proposals.
81. The one or more hardware storage devices of any one of 80, wherein the one or more data transformations comprise a depth feature calculation operation that provides a depth feature for each point associated with a point beam proposal of the one or more point beam proposals.
82. The one or more hardware storage devices of 81, wherein the input based upon the one or more point beam proposals comprises, for each point associated with a point beam proposal of the one or more point beam proposals, a concatenation of (i) a global coordinate representation, (ii) the local coordinate representation, and (iii) the depth feature.
83. The one or more hardware storage devices of any one or a combination of one or more of 69-82, wherein the second neural network comprises a PointNet model.
84. The one or more hardware storage devices of any one or a combination of one or more of 69-83, wherein the input based upon the one or more geometric embeddings comprises a concatenation of (i) the one or more geometric embeddings and (ii) a geometry type indicator.
85. The one or more hardware storage devices of 84, wherein the geometry type indicator comprises a one-hot vector denoting geometry type.
86. The one or more hardware storage devices of 85, wherein the one-hot vector is generated utilizing a pre-defined geometry dictionary that maps detected object class for the one or more detected objects to geometry type.
87. The one or more hardware storage devices of any one or a combination of one or more of 69-86, wherein the third neural network comprises a multilayer perceptron (MLP).
88. A method for inferring counts of objects, the method comprising: obtaining one or more point beam proposals associated with one or more detected objects in a scene, wherein each of the one or more point beam proposals corresponds to a 3D geometry extended from a 2D shape associated with a respective object of the one or more detected objects, and wherein each of the one or more point beam proposals is associated with a respective set of points of a point cloud; and determining a regression-based count estimation for the one or more detected objects in the scene utilizing the one or more point beam proposals.
89. The method of 88, wherein the one or more detected objects in the scene are detected utilizing one or more 2D images of the scene.
90. The method of 89, wherein the one or more detected objects in the scene are detected by utilizing the one or more 2D images as input to a convolutional neural network (CNN) based object detection module.
91. The method of any one or a combination of one or more of 89-90, wherein the one or more 2D images comprise one or more keyframes from a video stream.
92. The method of 91, wherein the one or more keyframes are selected from the video stream based upon camera pose and/or change in camera pose.
93. The method of any one or a combination of one or more of 88-92, wherein, for each of the one or more point beam proposals, the 3D geometry comprises a prismatic geometry computed by extending the 2D shape along a normal vector.
94. The method of 93, wherein the 2D shape comprises a 2D bounding box, and/or wherein the prismatic geometry comprises a rectangular prism.
95. The method of any one or a combination of one or more of 93-94, wherein the normal vector is determined relative to an image plane associated with the respective object.
96. The method of any one or a combination of one or more of 93-95, wherein, for each of the one or more point beam proposals, the 2D shape is projected onto an estimated location of the respective object of the one or more detected objects within the scene.
97. The method of 96, wherein, for each of the one or more point beam proposals, the 2D shape is projected utilizing depth data associated with at least part of the scene.
98. The method of 97, wherein the point cloud is acquired in parallel with acquisition of one or more 2D images of the scene.
99. The method of any one or a combination of one or more of 88-98, wherein determining the regression-based count estimation comprises applying input based upon the one or more point beam proposals to one or more neural networks.
100. The method of 99, wherein the input based upon the one or more point beam proposals is determined by applying one or more data transformations for the one or more point beam proposals.
101. The method of 100, wherein the one or more data transformations comprise an orthogonal rotation operation that causes each of the one or more point beam proposals to become orthogonal to a center axis.
102. The method of 101, wherein the one or more data transformations comprise a mean shift operation that provides a local coordinate representation for each point associated with a point beam proposal of the one or more point beam proposals.
103. The method of 102, wherein the one or more data transformations comprise a depth feature calculation operation that provides a depth feature for each point associated with a point beam proposal of the one or more point beam proposals.
104. The method of 103, wherein the input based upon the one or more point beam proposals comprises, for each point associated with a point beam proposal of the one or more point beam proposals, a concatenation of (i) a global coordinate representation, (ii) the local coordinate representation, and (iii) the depth feature.
105. The method of 104, wherein the one or more neural networks comprises a first neural network configured to receive the input based upon the one or more point beam proposals and output one or more geometric embeddings.
106. The method of 105, wherein the first neural network comprises a PointNet model.
107. The method of any one or a combination of one or more of 105-106, wherein the one or more neural networks comprises a second neural network configured to receive input based upon the one or more geometric embeddings and output the regression-based count estimation for the one or more detected objects in the scene.
108. The method of 107, wherein the input based upon the one or more geometric embeddings comprises a concatenation of (i) the one or more geometric embeddings and (ii) a geometry type indicator.
109. The method of 108, wherein the geometry type indicator comprises a one-hot vector denoting geometry type.
110. The method of 109, wherein the one-hot vector is generated utilizing a pre-defined geometry dictionary that maps detected object class for the one or more detected objects to geometry type.
111. The method of any one or a combination of one or more of 107-110, wherein the second neural network comprises a multilayer perceptron (MLP).
112. A method, comprising: providing a set of training data as input to a set of neural networks, the set of training data comprising 3D point cloud data and 2D image data depicting one or more objects in one or more scenes, the set of neural networks comprising: a first neural network configured to output one or more detected objects responsive to input 2D image data; a second neural network configured to output one or more geometric embeddings responsive to input based upon one or more point beam proposals generated from the one or more detected objects and the 3D point cloud data; and a third neural network configured to output a regression-based count estimation for the one or more detected objects responsive to input based upon the one or more geometric embeddings; obtaining a set of output regression-based count estimations for the one or more objects in the one or more scenes from the set of neural networks; determining loss based upon the set of output regression-based count estimations for the one or more objects in the one or more scenes and a set of ground truth counts associated with the training data; and updating the set of neural networks via gradient descent using the loss.
113. The method of 112, wherein the loss comprises a squared error loss.
114. The method of any one or a combination of one or more of 112-113, wherein the set of neural networks further comprises an attention module, and wherein updating the set of neural networks further comprises updating the attention module.
115. The method of any one or a combination of one or more of 112-114, wherein the first neural network comprises a convolutional neural network (CNN) based object detection module.
116. The method of any one or a combination of one or more of 112-115, wherein each of the one or more point beam proposals corresponds to a 3D geometry extended from a 2D shape associated with a respective object of the one or more detected objects, and wherein each of the one or more point beam proposals is associated with a respective set of points of the 3D point cloud data.
117. The method of 116, wherein, for each of the one or more point beam proposals, the 3D geometry comprises a prismatic geometry computed by extending the 2D shape along a normal vector.
118. The method of 117, wherein the 2D shape comprises a 2D bounding box, and/or wherein the prismatic geometry comprises a rectangular prism.
119. The method of any one or a combination of one or more of 117-118, wherein the normal vector is determined relative to an image plane associated with the respective object.
120. The method of any one or a combination of one or more of 117-119, wherein, for each of the one or more point beam proposals, the 2D shape is projected utilizing depth data associated with at least part of the scene.
121. The method of any one or a combination of one or more of 112-120, wherein the input based upon the one or more point beam proposals is determined by applying one or more data transformations for the one or more point beam proposals.
122. The method of 121, wherein the one or more data transformations comprise an orthogonal rotation operation that causes each of the one or more point beam proposals to become orthogonal to a center axis.
123. The method of 122, wherein the one or more data transformations comprise a mean shift operation that provides a local coordinate representation for each point associated with a point beam proposal of the one or more point beam proposals.
124. The method of any one of 123, wherein the one or more data transformations comprise a depth feature calculation operation that provides a depth feature for each point associated with a point beam proposal of the one or more point beam proposals.
125. The method of 124, wherein the input based upon the one or more point beam proposals comprises, for each point associated with a point beam proposal of the one or more point beam proposals, a concatenation of (i) a global coordinate representation, (ii) the local coordinate representation, and (iii) the depth feature.
126. The method of any one or a combination of one or more of 112-125, wherein the second neural network comprises a PointNet model.
127. The method of any one or a combination of one or more of 112-126, wherein the input based upon the one or more geometric embeddings comprises a concatenation of (i) the one or more geometric embeddings and (ii) a geometry type indicator.
128. The method of 127, wherein the geometry type indicator comprises a one-hot vector denoting geometry type.
129. The method of 128, wherein the one-hot vector is generated utilizing a pre-defined geometry dictionary that maps detected object class for the one or more detected objects to geometry type.
130. The method of any one or a combination of one or more of 112-129, wherein the third neural network comprises a multilayer perceptron (MLP).

1-20. (canceled)

21. A system for inferring counts of objects, the system comprising:
one or more processors; and
one or more hardware storage devices that store instructions that are executable by the one or more processors to configure the system to:
obtain one or more point beam proposals associated with one or more detected objects in a scene, wherein each of the one or more point beam proposals corresponds to a 3D geometry extended from a 2D shape associated with a respective object of the one or more detected objects, and wherein each of the one or more point beam proposals is associated with a respective set of points of a point cloud; and
determine a regression-based count estimation for the one or more detected objects in the scene utilizing the one or more point beam proposals.

22. The system of claim 21, wherein the one or more detected objects in the scene are detected utilizing one or more 2D images of the scene.

23. The system of claim 22, wherein the one or more detected objects in the scene are detected by utilizing the one or more 2D images as input to a convolutional neural network (CNN) based object detection module.

24. The system of claim 22, wherein the one or more 2D images comprise one or more keyframes from a video stream.

25. The system of claim 24, wherein the one or more keyframes are selected from the video stream based upon camera pose and/or change in camera pose.

26. The system of claim 21, wherein, for each of the one or more point beam proposals, the 3D geometry comprises a prismatic geometry computed by extending the 2D shape along a normal vector.

27. The system of claim 26, wherein the 2D shape comprises a 2D bounding box, and/or wherein the prismatic geometry comprises a rectangular prism.

28. The system of claim 26, wherein the normal vector is determined relative to an image plane associated with the respective object.

29. The system of claim 26, wherein, for each of the one or more point beam proposals, the 2D shape is projected onto an estimated location of the respective object of the one or more detected objects within the scene.

30. The system of claim 29, wherein, for each of the one or more point beam proposals, the 2D shape is projected utilizing depth data associated with at least part of the scene.

31. The system of claim 30, wherein the point cloud is acquired in parallel with acquisition of one or more 2D images of the scene.

32. The system of claim 21, wherein determining the regression-based count estimation comprises applying input based upon the one or more point beam proposals to one or more neural networks.

33. The system of claim 32, wherein the input based upon the one or more point beam proposals is determined by applying one or more data transformations for the one or more point beam proposals.

34. The system of claim 33, wherein the one or more data transformations comprise an orthogonal rotation operation that causes each of the one or more point beam proposals to become orthogonal to a center axis.

35. The system of claim 34, wherein the one or more data transformations comprise a mean shift operation that provides a local coordinate representation for each point associated with a point beam proposal of the one or more point beam proposals.

36. The system of claim 35, wherein the one or more data transformations comprise a depth feature calculation operation that provides a depth feature for each point associated with a point beam proposal of the one or more point beam proposals.

37. A system for training a set of neural networks to infer counts of objects, the system comprising:
one or more processors; and
one or more hardware storage devices that store instructions that are executable by the one or more processors to configure the system to:
provide a set of training data as input to a set of neural networks, the set of training data comprising 3D point cloud data and 2D image data depicting one or more objects in one or more scenes, the set of neural networks comprising:
a first neural network configured to output one or more detected objects responsive to input 2D image data,
a second neural network configured to output one or more geometric embeddings responsive to input based upon one or more point beam proposals generated from the one or more detected objects and the 3D point cloud data, and
a third neural network configured to output a regression-based count estimation for the one or more detected objects responsive to input based upon the one or more geometric embeddings;
obtain a set of output regression-based count estimations for the one or more objects in the one or more scenes from the set of neural networks;
determine loss based upon the set of output regression-based count estimations for the one or more objects in the one or more scenes and a set of ground truth counts associated with the training data; and
update the set of neural networks via gradient descent using the loss.

38. A method, comprising:
obtaining one or more point beam proposals associated with one or more detected objects in a scene,
wherein each of the one or more point beam proposals corresponds to a 3D geometry extended from a 2D shape associated with a respective object of the one or more detected objects, and
wherein each of the one or more point beam proposals is associated with a respective set of points of a point cloud; and
determining a regression-based count estimation for the one or more detected objects in the scene utilizing the one or more point beam proposals.

39. A method for training a set of neural networks to infer counts of objects, comprising:
providing a set of training data as input to a set of neural networks, the set of training data comprising 3D point cloud data and 2D image data depicting one or more objects in one or more scenes, the set of neural networks including
a first neural network configured to output one or more detected objects responsive to input 2D image data,
a second neural network configured to output one or more geometric embeddings responsive to input based upon one or more point beam proposals generated from the one or more detected objects and the 3D point cloud data, and
a third neural network configured to output a regression-based count estimation for the one or more detected objects responsive to input based upon the one or more geometric embeddings;
obtaining a set of output regression-based count estimations for the one or more objects in the one or more scenes from the set of neural networks;
determining loss based upon the set of output regression-based count estimations for the one or more objects in the one or more scenes and a set of ground truth counts associated with the training data; and
updating the set of neural networks via gradient descent using the loss.

40. One or more non-transitory hardware storage devices have stored therein instructions that are executable by one or more processors of a system to configure the system to perform the method according to claim 38.
